(19) United States
(12) Patent Application Publication
(10) Pub. No.: US 2021/0363708 A1
(43) Pub. Date: Nov. 25, 2021

(54) SURFACE MARKING ROBOT

(71) Applicant: Hewlett-Packard Development Company, L.P., Spring, TX (US)

(72) Inventors: Aviv Hassidov Pleser, Sant Cugat del Valles (ES); Borja Navas-Sanchez, Sant Cugat del Valles (ES); Ramon Viedma Ponce, Sant Cugat del Valles (ES); Antonio Rodriguez Avila, Sant Cugat del Valles (ES)

(73) Assignee: Hewlett-Packard Development Company, L.P., Spring, TX (US)

(21) Appl. No.: 17/258,491

(22) PCT Filed: Feb. 12, 2019
(86) PCT No.: PCT/US2019/017685

§ 371 Date: Jan. 7, 2021

(51) Int. Cl. E01C 23/22; G05D 1/02

(52) U.S. Cl. CPC E01C 23/222; G05D 2201/0202; G05D 1/0212

(57) ABSTRACT

In an example, a surface marking robot comprises a body, a print apparatus comprising a plurality of print nozzles mounted on the body, a position detection apparatus to determine a position of the robot, and a motion control system, to cause the robot to travel along the surface with an intended path. The print apparatus may be to deposit print material onto the surface from a first nozzle of the plurality of nozzles to form a line as the robot follows the intended path and upon detection by the position detection apparatus that the position of the robot has deviated from the intended path, the motion control system may be to perform a correction to a direction of travel of the robot such that the robot returns to the intended path; and the print apparatus may be to deactivate the first nozzle and activate a second nozzle of the plurality of nozzles, wherein the second nozzle may be chosen such that a distance between the first and second nozzles is to compensate for a deviation of the robots position from the intended path.

### BACKGROUND

Surface marking robots may be used to draw or print lines on a surface by depositing print agent while moving along the surface.

### BRIEF DESCRIPTION OF THE DRAWINGS

Non-limiting examples will now be described with reference to the accompanying drawings, in which:

FIG. 1 shows a schematic representation of an example surface marking robot.

FIG. 2 shows an example print apparatus of the surface marking robot of FIG. 1.

FIG. 3 shows a schematic flow chart of an example method.

FIG. 4 shows a schematic flow chart of another example method.

FIG. 5 shows a schematic representation of an example machine readable medium and a processor for performing example methods described herein.

### DETAILED DESCRIPTION

Surface marking robots, also referred to herein as surface marking vehicles, which may be, for example, autonomous vehicles may be used for printing images such as lines on surfaces for applications such as construction and street marking. However, factors such as uneven ground, external impacts, objects or debris in the robots trajectory, or for example wheel slippage caused by a patch of oil or similar on the ground can cause the robot to deviate from an intended path, causing inaccuracies in the position of the printed line.

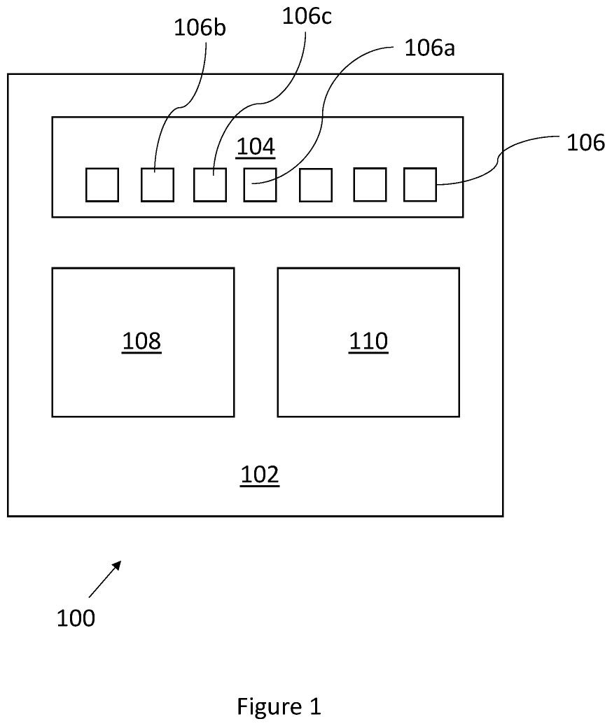

FIG. 1 shows a surface marking robot 100 comprising a body 102 and a print apparatus 104 comprising a plurality of print nozzles 106 mounted on the body 102. The robot 100 also includes a motion control system 108, to cause the robot 100 to travel along the surface with an intended path or trajectory. For example, the motion control system 108 may comprise a plurality of wheels connected with a motor, or any suitable propulsion system. In some examples, the motion control system 108 may also comprise a processor to receive and execute instructions defining an intended path for the robot 100 to follow. In some examples the motion control system 108 may comprise a machine readable medium having stored instructions defining a predefined intended path for the robot 100 to follow. In other examples the motion control system 108 may define an intended path for the robot 100. In some examples, the motion control system 108 may comprise control circuitry to control wheels, a motor or other propulsion apparatus mounted on the body 102 of the robot 100 to control a direction (and in some examples, speed) of the robot 100. In some examples, the motion control system may be a microcontroller following a trajectory servo in communication with a propulsion system comprising motor driver electronics to supply force to a set of wheels.

The robot 100 also includes a position detection apparatus 110 for detecting a position of the robot 100. The position detection apparatus 110 may for example, comprise a sensor, or, in some examples, a plurality of sensors. The sensor(s) 112 may be any kind of suitable position sensor such as rotary encoders located on wheels of the robot, a camera located on the body of the robot, a Light Detection and Ranging (LIDAR) system, an inertial mechanical unit to sense accelerations and direction of the robot, a combination including at least some of the previously-mentioned position sensors or any other suitable kind of position sensor. In some examples, information from the sensor(s) 112 may be compared with a servo ideal path to detect deviations. For example, accelerations in an axis other than that defined by the servo ideal path can indicate that the robot is not following the defined path. In some examples a determination that rotary encoders on the robot's wheels are not increasing steadily can provide an indication that the robot has deviated from the defined path. The position detection apparatus 110 may comprise processing circuitry to determine whether a determined position matches an intended path of the robot 100, which may be held by the motion control apparatus 108. In some examples, the robot's position may be monitored by a sensor, for example a camera, located externally to the robot and the position detection apparatus may comprise a processor to receive position information for the robot. In some examples, the position detection apparatus 110 and/or the motion control apparatus 108 may determine a magnitude and direction of the difference between the robot's current position and its intended path. In some examples, detecting that the position of the robot has deviated from the intended path comprises detecting that the position of the robot has deviated from the intended path by more than a predefined threshold distance. The threshold distance may be set at, for example 2 cm. The predefined threshold distance may be, for example, set at a distance based on the distance between a first nozzle 106a of the nozzles 106 and a nozzle located adjacent to the first nozzle 106a. In some examples, the angle with which the robot turns back to the path (i.e. the direction that the robot follows when returning to the intended path) may be selected based on which angle will result in a straighter overall trajectory. In other examples, the robot may take any suitable angle that orientates it toward the intended path.

In use of the robot 100, the print apparatus 104 deposits print material onto the surface from a first nozzle 106a (for example, a central nozzle) of the plurality of nozzles 106 to form a line, as the robot 100 follows an intended path. Upon detection by the sensor 112 that the position of the robot 100 has deviated from the intended path: the motion control system 108 performs a correction to a direction of travel of the robot 100 such that the robot 100 returns to the intended path; and the print apparatus 104 deactivates the first nozzle 106a and activate a second nozzle 106b of the plurality of nozzles 106. The second nozzle 106b is chosen such that the distance between the first and second nozzles 106a, 106b is to compensate for a deviation of the robot's position from the intended path. In some examples, the distance between the first and second nozzles may equal the distance between the robot's position and the intended path. In some examples, the second nozzle 106b may be chosen as the nearest nozzle of the plurality of nozzles to the intended path

Switching to depositing ink from a different nozzle enables unintended deviations in the robot's path to be compensated for, which increases the accuracy of lines printed by the robot 100. Switching to a different nozzle for deposition of print agent is a faster and more accurate method than, for example, moving the nozzle 106a itself or correcting the path of the robot. Correcting the direction of the robot 100 at the same time as providing the correction of the print apparatus 104 balances providing a fast correction to small deviations from the path whilst preemptively preventing large deviations by correcting the path of the robot 100 before the intended path becomes out of reach of the nozzles 106.

In some examples, the nozzles 106 are fixed relative to the body 102, e.g. the nozzles are mounted on the body 102 rather than being mounted on a moveable print carriage. Mounting the nozzles 106 in a fixed arrangement relative to the body 102 provides a more robust arrangement than mounting on a moveable printer carriage, which improves ease of maintenance for the robot 100.

In some examples, the nozzles 106 are arranged in a row, perpendicular to a direction of travel of the robot 100. This arrangement enables a range of degrees of deviation from the intended path to be compensated for by using nozzles 106 at different positions along the row.

In some examples, the nozzles 106 are spaced from each other by a distance of between 5 and 20 mm. This spacing enables even small deviations from the intended path of the robot 100 to be compensated for by switching from the first nozzle 106a to another nozzle of the plurality of nozzles 106.

In some examples, the plurality of nozzles 106 comprises between 5 and 20 nozzles. Thus, a range of deviation distances can be corrected for.

In some examples, the position detection apparatus 110 detects that the robot 100 has deviated from its intended path by: determining with the sensor 112 the current position of the robot 100 and comparing the current position of the robot 100 with expected position information for the robot 100. In some examples, the position detection apparatus 110 is to determine a direction and magnitude of the difference between the current position and the expected position. In some examples, the position detection apparatus 110 continuously monitors the position of the robot 100. In other examples, the position detection apparatus 110 periodically detects the position of the robot 100.

In some examples, detecting that the position of the robot 100 has deviated from its intended path comprises detecting that the robot 100 has deviated from its intended path by more than a predefined threshold distance. In some examples, the predefined threshold distance may be set at a distance which is greater than half the distance between the first nozzle 106a and a nozzle located adjacent to the first nozzle 106a in the plurality of nozzles 106.

In some examples, upon detection by the position detection apparatus 110 that the robot 100 has deviated from its intended path, the print apparatus 104 may calculate which nozzle of the plurality of nozzles 106 is currently closest to a current intended path position The print apparatus 104 may then deactivate the first nozzle 106a and activate whichever of the plurality of nozzles 106 is currently closest to the intended path.

As the robot's path is corrected by the motion control apparatus 108, the distance between the intended path and the actual position of the robot 100 will decrease. In some examples, the print apparatus 104 is to, as the robot 100 returns to the intended path, deactivate the second nozzle 106b and reactivate the first nozzle 106a. That is, the print apparatus 104 stops depositing print agent from the second nozzle 106b and starts to deposit print agent from the first nozzle 106a again. This enables the printed line to be printed accurately along the intended path as the robot 100 reconverges with the intended path.

In some examples, where the first nozzle 106a and the second nozzle 106b are not located adjacent to each other, the print apparatus 104 may, in use of the robot, as the distance between the robot 100 and the intended path decreases, deactivate the second nozzle 106b, and activate a third nozzle 106c located between the first and second nozzles 106a, 106b and as the robot 100 returns to the intended path, deactivate the third nozzle 106c and reactivate the first nozzle 106a. In some examples, the print apparatus 104 is to activate and deactivate successive adjacent nozzles of the plurality of nozzles 106 in sequence as the robot 100 returns to the intended path, such that the printed line corresponds to the intended path. This may help to provide continuity or smoothness of the printed line. In some examples, the nozzle that is activated at any given time is whichever nozzle is determined to be closest to the intended path at that time. In this way, the robot 100 ensures that the line is printed along the intended path, even if the robot 100 is not following that path itself.

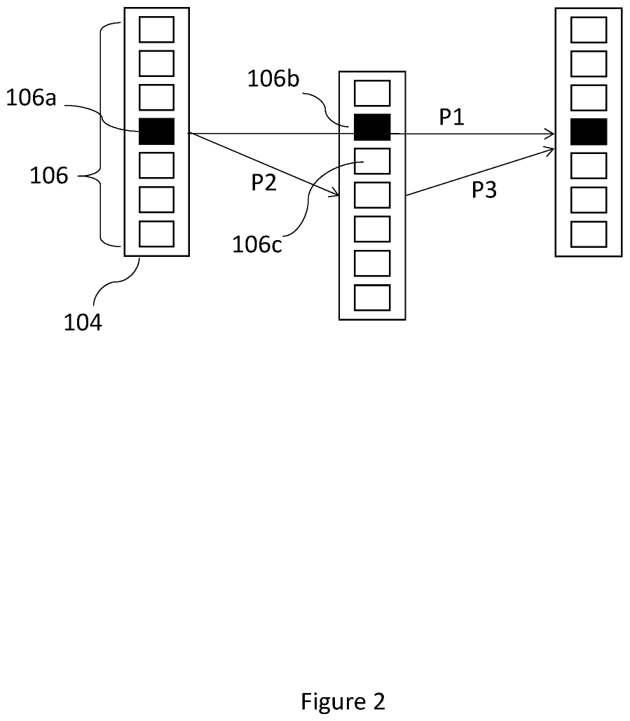

FIG. 2 shows an example of the print apparatus 104 of the robot 100 of FIG. 1 in use. As shown in this Figure, robot 100 initially prints a line by depositing print agent from a first, central nozzle 106a of nozzles 106 of print apparatus 104 while following an intended path, to print a line along the intended path. The robot 100 is instructed to follow intended path P1. However, the robot 100 travels along path P2 instead (for example, due to an uneven surface, wheel slippage etc.). Once a difference between the intended path P1 and the actual path P2 has been determined by position detection apparatus 110, nozzle 106a is deactivated and a second nozzle 106b is activated, which is the nozzle located nearest to the intended path P1, as determined based on the determined difference. In addition, the motion control apparatus 108 controls the motion of the robot 100 such that the robot 100 follows path P3, such that the robot 100 returns to the path P1. In some examples, the print apparatus 104 may print the line from the second nozzle 106b until the robot 100 returns to the intended path P1. In other examples, the print apparatus 104 may deactivate the second nozzle 106b once that nozzle is no longer the closest nozzle to the intended path P1 and may activate a third nozzle 106c located in between the first and second nozzles 106a, 106b. In some examples, nozzles 106 may be activated and deactivated one at a time, in sequence, as the robot 100 moves back to the intended path by activating (and therefore printing from) whichever nozzle is determined to be closest to the intended path at any given time. As the actual path P3 rejoins the intended path P1, the first nozzle 106a is reactivated to continue printing the line along the intended path. Using a first nozzle 106a that is located centrally in the plurality of nozzles 106 enables maximum error correction due to deviation in either direction. However, in some examples the first nozzle may be located in a different position (for example when deviation is more likely in one direction than another.

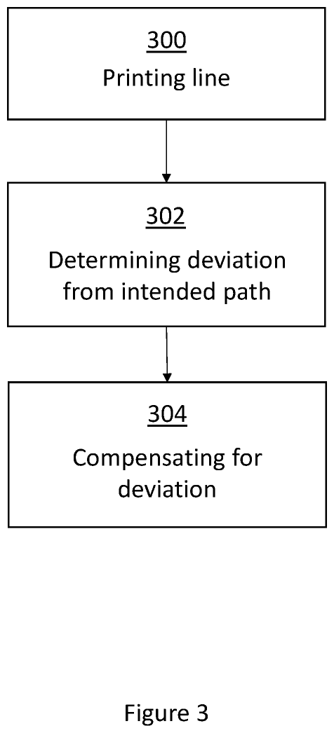

FIG. 3 shows a method, which may be a method of printing a line. The method may be performed by a surface marking robot or vehicle such as the surface marking robot 100 described in relation to FIGS. 1 and 2. Block 300 of the method comprises printing a line by depositing ink from a first print nozzle of a plurality of print nozzles of a surface marking vehicle comprising a plurality of print nozzles and a propulsion mechanism to cause the vehicle to travel along a surface along a path. Block 302 of the method comprises determining that the vehicle has deviated from an intended path, for example by using techniques as described above. Block 304 of the method comprises compensating for the deviation by deactivating the first nozzle and depositing ink from a second nozzle, wherein the second nozzle is spaced from the first nozzle by a distance proportional to a determined offset between the position of the vehicle and the intended path while controlling the direction of the vehicle to return to the particular path.

Therefore, the method of FIG. 3 provides a responsive and robust method for correcting errors in a line printed by a surface marking vehicle due to path deviation of the vehicle.

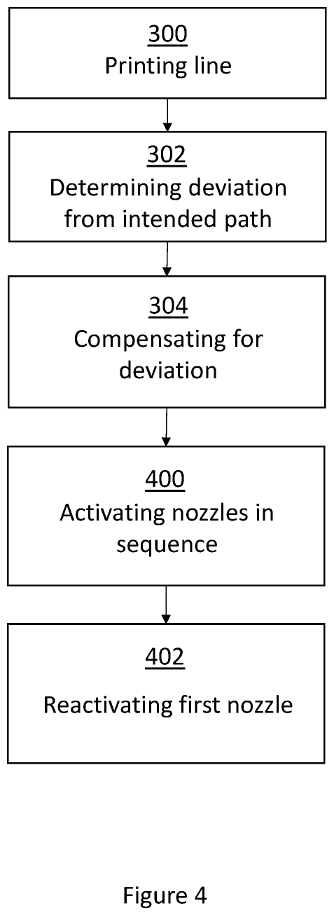

FIG. 4 shows a further method, which may be a method of printing a line. The method of FIG. 4 may be performed by a surface marking robot such as the surface marking robot described in relation to FIGS. 1 and 2. FIG. 4 includes blocks 300 to 304, as described above in relation to FIG. 3. FIG. 4 also includes block 400 which comprises activating and deactivating successive adjacent nozzles of the plurality of nozzles in sequence as the vehicle returns to the particular path, such that the printed line corresponds to the intended path. Block 402 comprises, once the surface marking vehicle has returned to the particular path, reactivating the first nozzle.

Therefore, the method of FIG. 4 returns the robot to its intended position whilst providing a high level of continuity of the printed line, and keeps printing the line along the intended path as the actual path of the robot 100 reconverges with the intended path.

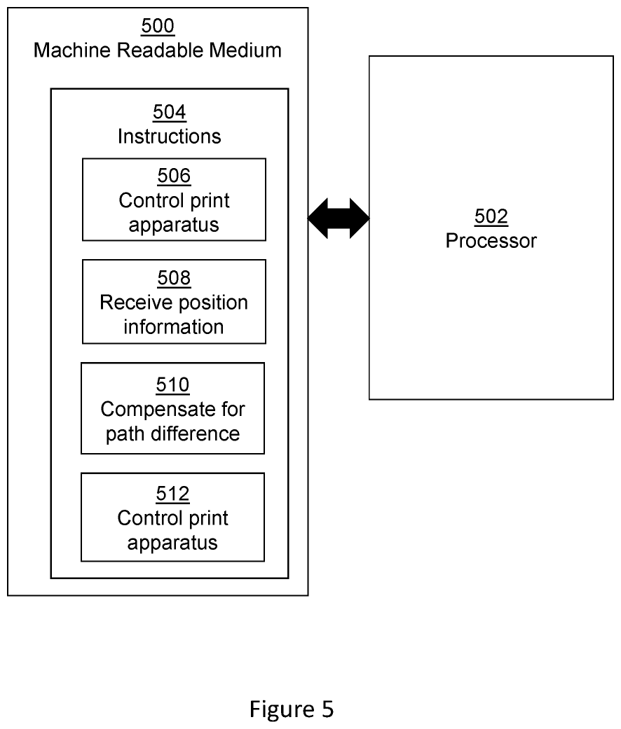

FIG. 5 shows a schematic representation of a tangible machine readable medium 500 comprising instructions 504 which, when executed, cause a processor 502 to perform example processes described herein. In an example, the machine readable medium 500 comprises a set of instructions which when executed cause the processor 502 to perform a method as described with reference to FIG. 3 or FIG. 4. In an example, the machine readable medium 500 comprises a set of instructions 504 which, when executed by a processor 502 cause the processor 502 to control a self propelled surface marking robot to move along a path while marking a line on the surface using a print apparatus of the surface marking robot, the print apparatus comprising an arrangement of print nozzles.

The instructions 504 comprise instructions 506 to control the print apparatus to deposit print agent from a first nozzle of the arrangement of nozzle. The instructions 504 further comprise instructions 508 to receive position information for the robot. The instructions 504 also include instructions 510 to in response to detecting a difference between an intended path for the robot and an actual path of the robot, control the print apparatus to deposit print agent from a second nozzle to compensate for the difference between the intended and actual paths while adjusting a direction of the surface marking robot; and instructions 512 to, in response to detecting that the actual path has re-converged with the intended path, controlling the print apparatus to deposit print agent from the first nozzle of the plurality of nozzles.

In some examples, the machine readable medium may comprise instructions to, as the distance between the robot and the intended path decreases, deactivate the second nozzle and deposit print agent from a third nozzle located between the first and second nozzles and as the robot returns to the intended path, deactivate the third nozzle and deposit print agent from the first nozzle.

In some examples, the machine readable medium may comprise instructions to as the distance between the robot and the intended path decreases, activate and deactivate each nozzle between the second nozzle and the first nozzle in sequence such that the print agent is deposited along the intended path as the actual path returns to the intended path.

In some examples, the machine readable medium 500 may form part of a surface marking robot, e.g. the surface marking robot 100 of FIG. 1. In other examples, the machine readable medium 500 may be located externally to the robot 100, and be in communication with the robot using a wireless communication system such as Wi-Fi, Bluetooth, or any suitable communication system. The present disclosure is described with reference to flow charts. Although the flow charts described above show a specific order of execution, the order of execution may differ from that which is depicted. Blocks described in relation to one flow chart may be combined with those of another flow chart.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A surface marking robot comprising:
a body;
a print apparatus comprising a plurality of print nozzles mounted on the body;
a position detection apparatus to determine a position of the robot;
a motion control system, to cause the robot to travel along the surface with an intended path;
wherein the print apparatus is to deposit print material onto the surface from a first nozzle of the plurality of nozzles to form a line as the robot follows the intended path; and
wherein upon detection by the position detection apparatus that the position of the robot has deviated from the intended path:
(i) the motion control system is to perform a correction to a direction of travel of the robot such that the robot returns to the intended path; and
(ii) the print apparatus is to deactivate the first nozzle and activate a second nozzle of the plurality of nozzles, wherein the second nozzle is chosen such that a distance between the first and second nozzles is to compensate for a deviation of the robot's position from the intended path.

2. A surface marking robot according to claim 1, wherein the nozzles are fixed relative to the body.

3. A surface marking robot according to claim 1, wherein the nozzles are arranged in a row, perpendicular to a direction of motion of the robot.

4. A surface marking robot according to claim 1, wherein the print apparatus is to, as the robot returns to the intended path, deactivate the second nozzle and reactivate the first nozzle.

5. A surface marking robot according to claim 4, wherein the print apparatus is to, as the distance between the robot and the intended path decreases, deactivate the second nozzle and activate a third nozzle located between the first and second nozzles and as the robot returns to the intended path, deactivate the third nozzle and reactivate the first nozzle.

6. A surface marking robot according to claim 1, wherein the plurality of nozzles are spaced from each other in a direction perpendicular to a direction of motion of the robot, by a distance of between 5 and 20 mm.

7. A surface marking robot according to claim 1, wherein the plurality of nozzles comprises between 5 and 20 nozzles.

8. A surface marking robot according to claim 1, wherein detection that the position of the robot has deviated from the intended path comprises detecting that the position of the robot has deviated from the intended path by more than a predefined threshold distance.

9. A method comprising:
printing a line by depositing ink from a first print nozzle of a plurality of print nozzles of a surface marking vehicle comprising a plurality of print nozzles and a propulsion mechanism to cause the vehicle to travel along a surface along a path;
determining that the vehicle has deviated from an intended path; and
compensating for the deviation by deactivating the first nozzle and depositing ink from a second nozzle, wherein the second nozzle is spaced from the first nozzle by a distance proportional to a determined offset between a position of the vehicle and the intended path while controlling a direction of the vehicle to return to the intended path.

10. A method according to claim 9, comprising, once the surface marking vehicle has returned to the intended path, reactivating the first nozzle.

11. A method according to claim 9 comprising activating and deactivating successive adjacent nozzles of the plurality of nozzles in sequence as the vehicle returns to the intended path, such that a line printed by the vehicle as the vehicle returns to the intended path is printed along the intended path.

12. A method according to claim 9 wherein the second nozzle is chosen from the plurality of nozzles such that the determined offset corresponds to a distance between the first and second nozzles.

13. A tangible machine readable medium comprising a set of instructions which, when executed by a processor cause the processor to:
control a self propelled surface marking robot to move along a path while marking a line on the surface using a print apparatus of the surface marking robot, the print apparatus comprising an arrangement of print nozzles;
control the print apparatus to deposit print agent from a first nozzle of the arrangement of nozzles;
receive position information for the robot;
in response to detecting a difference between an intended path for the robot and an actual path of the robot;
control the print apparatus to deposit print agent from a second nozzle to compensate for the difference between the intended and actual paths while adjusting a direction of the surface marking robot; and
in response to detecting that the actual path has re-converged with the intended path, controlling the print apparatus to deposit print agent from the first nozzle of the arrangement of nozzles.

14. A tangible machine readable medium according to claim 13, further comprising instructions to, as the distance between the robot and the intended path decreases, deactivate the second nozzle and deposit print agent from a third nozzle located between the first and second nozzles and as the robot returns to the intended path, deactivate the third nozzle and deposit print agent from the first nozzle.

15. A tangible machine readable medium according to claim 13, further comprising instructions to, as the distance between the robot and the intended path decreases, activate and deactivate each nozzle between the second nozzle and the first nozzle in sequence such that the print agent is deposited along the intended path as the actual path returns to the intended path.
